(19) United States
(12) Patent Application Publication
(10) Pub. No.: US 2016/0147323 A1
(43) Pub. Date: May 26, 2016

(54) TOUCH CONTROL PANEL STRUCTURE AND METHOD OF MANUFACTURING THE SAME

(71) Applicants: Interface Optoelectronics Corporation, Shenzhen (CN); General Interface Solution Limited, Miaoli County (TW)

(72) Inventors: Ying-Chieh CHIANG, Shenzhen (CN); Tzu-Hsiang LIN, Shenzhen (CN); Yen-Heng HUANG, Taoyuan County (TW)

(21) Appl. No.: 14/555,727

(22) Filed: Nov. 28, 2014

(30) Foreign Application Priority Data
Nov. 21, 2014 (CN) 201410679926.8

(51) Int. Cl. G06F 3/041

(52) U.S. Cl. CPC G06F 3/041; G06F 2203/04103

(57) ABSTRACT

A method of manufacturing touch control panel structure includes providing a substrate. Then a transparent electrode layer is formed on a display area of the substrate. Next, a metal wiring layer is formed on a peripheral area of the substrate. The peripheral area surrounds the display area. Finally, the substrate is cut to form a touch control panel structure. A cutting line goes through the metal wiring layer, and an edge of the metal wiring layer is flushed against an edge of the substrate.

### RELATED APPLICATIONS

This application claims priority to Chinese Application Serial Number 201410679926.8, filed Nov. 21, 2014, which is herein incorporated by reference.

### BACKGROUND

1. Field of Invention

The present invention relates to a touch control panel structure and method of manufacturing the same.

2. Description of Related Art

A surface area of a conventional touch control panel can be dived into tow portions: invisible area and visible area. Invisible area surrounds the periphery of the visible area to form a frame. The transparent touch control electrodes are disposed on the visible area, and other non-transparent wiring or components are disposed on the invisible area. Typically, the invisible area is shielded by black material such that a user will not see the wiring or components on the invisible area. The invisible area is transformed into a black frame around the visible premises. The visible area allows user to control the device.

Due to the ever reducing size of a mobile device, the dimension of the frame is narrower. Therefore, there is a great need to reduce the frame dimension and meet the technical standard at the same time so as to provide a compact mobile device.

### SUMMARY

The invention provides a touch control panel structure and method of manufacturing the same, which will have narrower frame.

According to an embodiment of the instant disclosure, a method of manufacturing touch control panel structure includes providing a substrate. Then a transparent electrode layer is formed on a display area of the substrate. Next, a metal wiring layer is formed on a peripheral area of the substrate. The peripheral area surrounds the display area. Finally, the substrate is cut to form a touch control panel structure. A cutting line goes through the metal wiring layer and an edge of the metal wiring layer is flushed against an edge of the substrate.

In one aspect of the instant disclosure, the metal wiring layer has a thickness smaller than 10 μm.

In another aspect of the instant disclosure, the metal wiring layer comprises an inner metal wiring and a peripheral metal wiring, a side of the peripheral metal wiring is flushed against the edge of the substrate, the cutting line goes through the peripheral metal wiring, and an interval between an outer edge of the inner metal wiring and the cutting line is approximately 200 to 350 μm.

In still another aspect of the instant disclosure, a cutting strength is approximately 1500 to 3100 lb/m².

In another aspect of the instant disclosure, the method further includes forming a transparent dielectric layer on the peripheral area and the metal wiring layer. The transparent dielectric layer is made of insulating polymers or metal oxides mixing with polymers, and the transparent dielectric layer has a thickness of approximately 10 to 200 μm.

In another aspect of the instant disclosure, the method further includes forming a transparent dielectric layer on the peripheral area and the metal wiring layer. The transparent dielectric layer is made of non-conductive thin film, an interval between an edge of the transparent dielectric layer proximate to the display area and the metal wiring layer is approximately 5 to 100 nm.

In another aspect of the instant disclosure, a cutting strength is approximately 1500 to 4000 lb/m².

According to an embodiment of the instant disclosure, a touch control panel structure is provided, including a substrate, a transparent electrode layer and metal wiring layer. The substrate has a display area and a peripheral area, wherein the peripheral area surrounds the display area. The transparent electrode layer is disposed on the display area. The metal wiring layer is disposed on the peripheral area, and an edge of the metal wiring layer is flushed against an edge of the substrate.

In one aspect of the instant disclosure, the touch control panel structure further includes a transparent dielectric layer covering the peripheral area and the metal wiring layer.

In another aspect of the instant disclosure, the transparent dielectric layer is made of insulating polymers or metal oxides mixing with polymers, and the transparent dielectric layer has a thickness of approximately 10 to 200 μm.

In still another aspect of the instant disclosure, the transparent dielectric is made of non-conductive thin film, an interval between an edge of the transparent dielectric layer proximate to the display area and the metal wiring layer is approximately 5 to 100 nm.

In the instant disclosure, a side of the metal wiring layer is flushed against the outer edge of the substrate. When cutting the substrate to form the touch control panel structure, the cutting knife goes through the metal wiring layer. In this way, the edge of the touch control panel does not have an extra spare area reserved for cutting, and therefore the frame is narrower. The mobile device can shrink in size as well.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a plan view of a substrate in accordance with an embodiment of the instant disclosure;

FIGS. 2A to 2G are cross-sectional views along line 2-2 in FIG. 1 showing steps of manufacturing touch control panel structure in accordance with an embodiment of the instant disclosure;

FIGS. 3A to 3D are cross-sectional views along line 2-2 in FIG. 1 showing a method of manufacturing touch control panel structure in accordance with another embodiment of the instant disclosure; and

FIG. 4 is a cross-sectional view along line 2-2 in FIG. 1 showing a step in a method of manufacturing touch control panel structure in accordance with an embodiment of the instant disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Conventional method of manufacturing touch control panel will save a cutting zone along a frame of the edge of the panel for cutting. The cutting knife cuts through this area. However, this method results in a redundant area along the edge, and the frame is therefore broader. The instant disclosure provides a method of manufacturing touch control panel structure. By specialized design, a cutting zone is not required such that the frame is narrower and the overall device size shrinks as well.

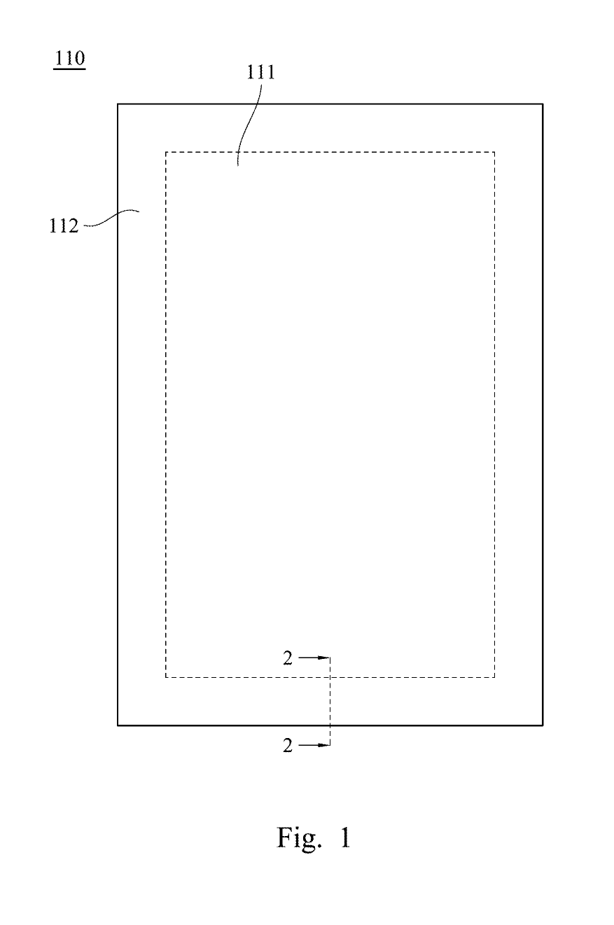

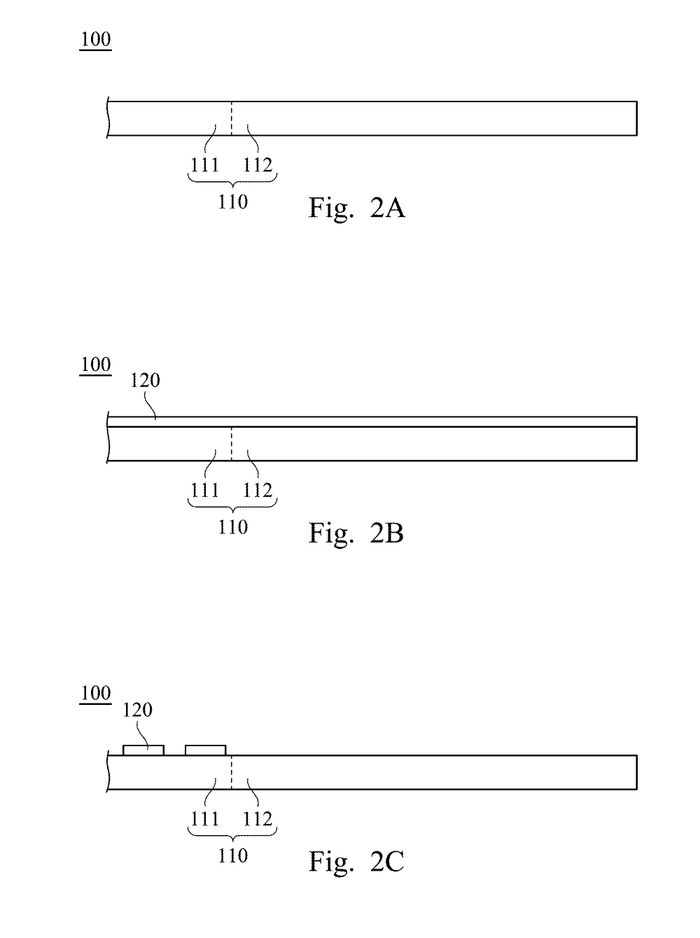

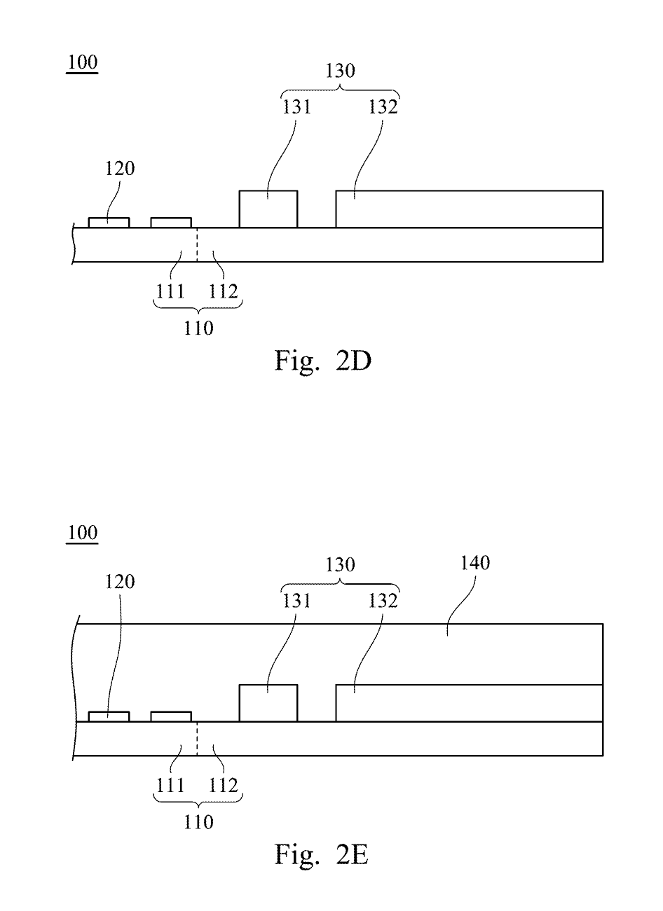

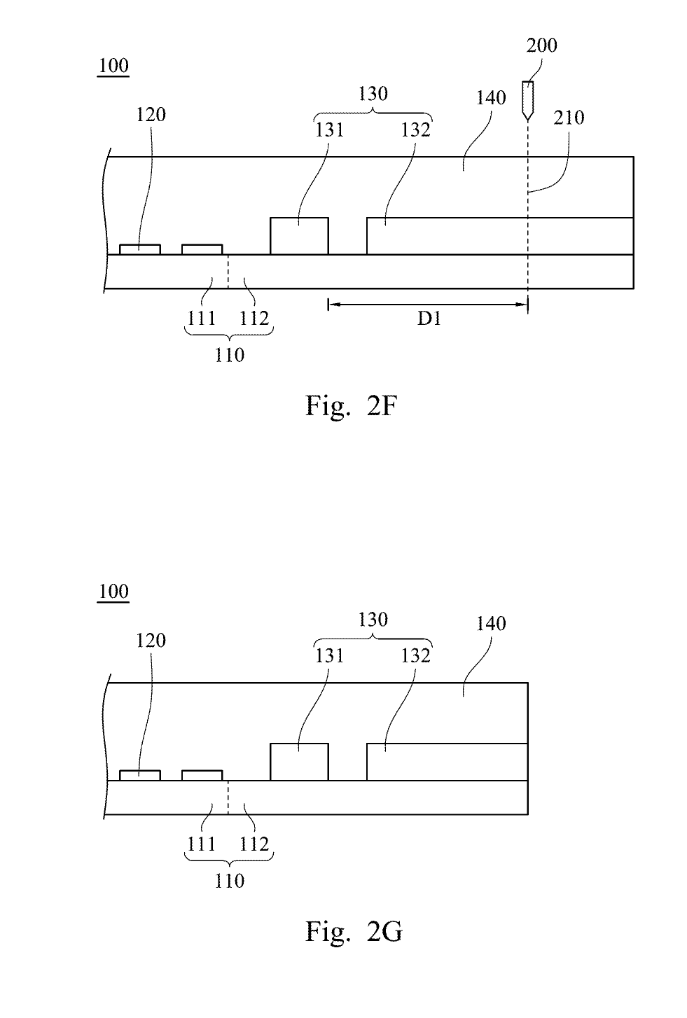

FIG. 1 is a plan view showing a substrate 110 in accordance with an embodiment of the instant disclosure. FIGS. 2A to 2G are cross-sectional views along line 2-2 in FIG. 1 showing steps of the method of manufacturing a touch control panel structure 100. As shown in FIG. 1, the substrate 110 has a display area 111 and a peripheral area 112. The peripheral area 112 surrounds the display area 111, and the peripheral area 112 serves as a frame for the touch control panel structure 100. The method of manufacturing the touch control panel structure 100 is elaborated as follow.

As shown in FIGS. 1 and 2A. Firstly, the substrate 110 is provided. In one embodiment, the substrate 110 is made of polyethylene terephthalate (PET), and the instant disclosure is not limited thereto. In another embodiment, the substrate can be made of glass.

As shown in FIGS. 2B and 2C, a transparent electrode layer 120 is formed on the display area 111 of the substrate 110. More specifically, as shown in FIG. 2B, the transparent electrode layer 120 is formed on the substrate 110. Next, as shown in FIG. 2C, the transparent electrode layer 120 is patterned on the display area 111 of the substrate 110.

The transparent electrode layer 120 can be made of indium tin oxide (ITO). The transparent electrode layer 120 can be formed by etching and deposition, including plasma enhanced chemical vapour deposition (PECVD).

As shown in FIG. 2D, a metal wiring layer 130 is formed on the peripheral area 112 of the substrate 110. A side of the metal wiring layer 130 is flushed against an outer edge of the substrate. More specifically, the metal wiring layer 130 includes at least an inner metal wiring 131 and a peripheral wiring 132. A side of the peripheral wiring 132 is flushed against the outer edge of the substrate 110. The inner metal wiring 131 electrically connects the transparent electrode layer 120 on the display area 111 with external control modules (e.g., flexible printed circuit board). The peripheral metal wiring 132 can electrically connects to external ground (e.g., ground of the flexible printed circuit board) so as to prevent electrostatic.

In one embodiment of the instant disclosure, the metal wiring layer 130 has a thickness smaller than 10 μm. It should be noted that the embodiment does not intend to limit the thickness of the instant disclosure. For one of ordinarily skill in the art, the thickness of the metal wiring layer 130 may vary according to practical requirement.

The metal wiring layer 130 can be made of silver, copper, aluminium, gold, nickel or titanium. It should be noted that the abovementioned materials of the metal wiring layer 130 do not intend to limit the instant disclosure. For one of ordinarily skill in the art, the material of the metal wiring layer 130 may vary according to practical requirement.

In one embodiment, the metal wiring layer 130 is formed by screen printing, and the instant disclosure is not limited thereto. In another embodiment, the metal wiring layer 130 can be formed by coating.

As shown in FIG. 2E, a transparent insulation layer 140 is formed on the substrate 110, transparent electrode layer 120 and metal wiring layer 130. The transparent insulation layer 140 can be made of optical clear adhesive such that the touch control panel can be attached to other structure. The transparent insulation layer 140 may be formed by coating, and the instant disclosure is not limited thereto.

As shown in FIGS. 2F and 2G, the substrate 110 is cut and the touch control panel structure 100 is formed. A cutting knife 200 goes through the metal wiring layer 130 according to a cutting line 210, and an edge of the metal wiring layer 130 is flushed against the outer edge of the substrate 110.

More specifically, the cutting line 210 goes through peripheral metal wiring 132. An interval D1 measures from an outer edge of the inner metal wiring 131 to the cutting line 210 is approximately 200 to 350 μm.

The substrate 110 can be cut by stamping. A cutting strength may fall between 1500 and 3100 lb/m². It should be noted that the abovementioned cutting method does not intend to limit the instant disclosure. For one of ordinarily skill in the art, the cutting method may vary according to requirement.

A side of the metal wiring layer 130 is coplanar with the outer edge of the substrate 110. When cutting the substrate 110 to form the touch control panel 100, the cutting knife 200 goes through the cutting line 210 which passes the metal wiring layer 130. As a result, the edge of the touch control panel 100 does not have a redundant area for cutting, and the frame is therefore narrower to achieve an even smaller size.

Because the thickness of the metal wiring layer 130 is less than 10 μm and one side of the metal wiring layer 130 is coplanar with the outer edge of the substrate 110, even if the cutting knife 200 goes through the cutting line 210 that passes through the metal wiring layer 130, the edge area of the touch control panel 100, i.e., the stacking structure of the substrate 110, metal wiring layer 130 and transparent insulation layer 140, will not peel off.

In addition, because the interval D1 between the outer edge of the inner metal wiring 131 and the cutting line 210 is approximately 200 to 350 μm within 150 μm tolerance, the interval D1 is larger than 200 μm. Therefore, the width of the peripheral metal wiring 132 will not be too small. Although the frame is narrower, the ability of electrostatic prevention provided by the touch control panel 100 is not compromised.

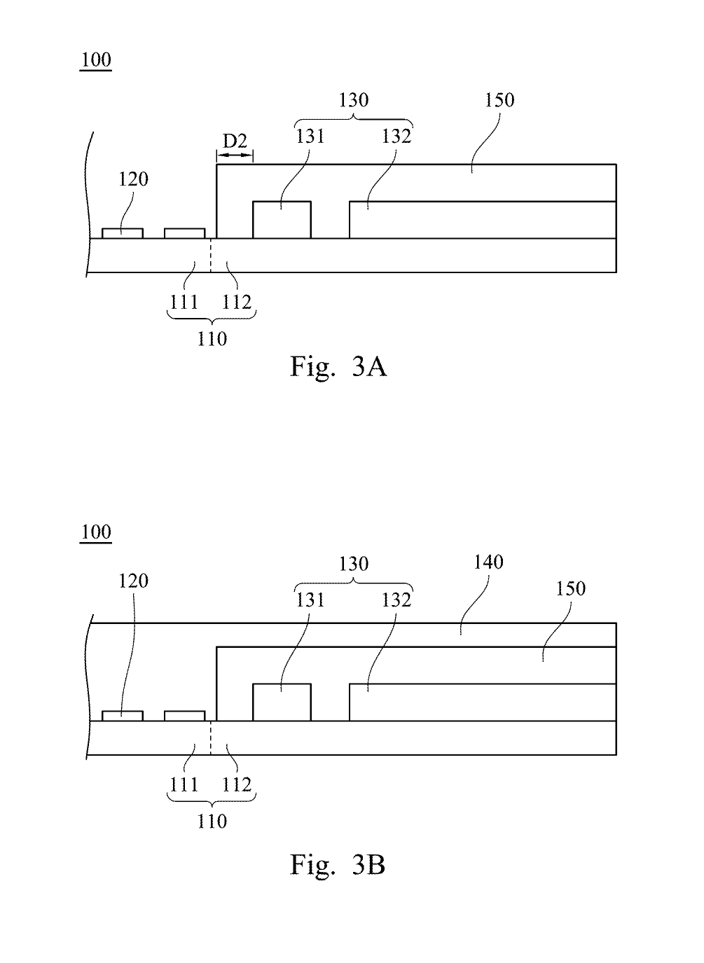

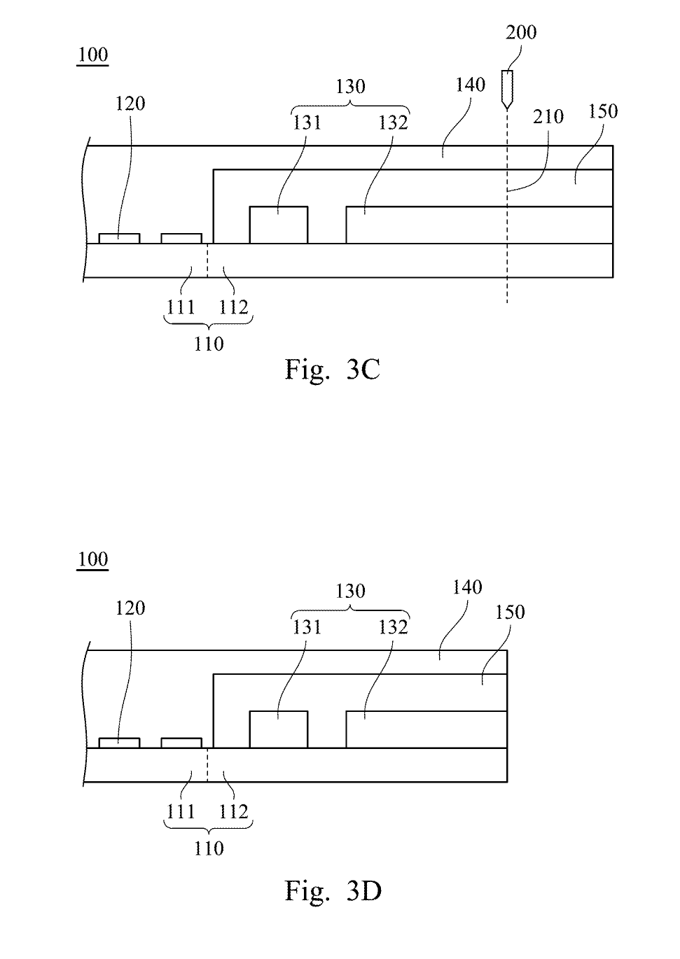

FIGS. 3A to 3D are cross-sectional views along line 2-2 in FIG. 1 showing steps of a method of manufacturing touch control panel 100 in accordance with another embodiment of the instant disclosure. This embodiment is similar to the previous embodiment, and the difference is elaborated hereinafter.

As shown in FIG. 3A, the method of manufacturing the touch control panel 100 further includes the formation of a transparent dielectric layer 150 on the peripheral area 112 and the metal wiring layer 130. The transparent dielectric layer 150 serves as a protection layer, reinforces the hardness of the metal wiring layer 130 and increases yielding rate after cutting.

More specifically, an interval D2 between an edge of the transparent dielectric layer 150 proximate to the display area 111 and the metal wiring layer 130 is approximately 5 to 100 nm. This interval defines the position of the transparent dielectric layer 150, and the display area 111 does not have the transparent dielectric layer 150 so as to maintain its high transparency.

The transparent dielectric layer 150 can be formed by screen printing, and the instant disclosure is not limited thereto. In another embodiment, the transparent dielectric layer 150 can be formed by coating.

The transparent dielectric layer 150 may be made of insulating polymers or metal oxides mixing with polymers or other non-conductive materials. It should be noted that the abovementioned materials of the transparent dielectric layer 150 are exemplary, and the instant disclosure is not limited thereto. For one of ordinarily skill in the art, the material of the transparent dielectric layer 150 may vary according to practical requirement.

The transparent dielectric layer 150 has a thickness between 10 to 200 μm. It should be noted that the abovementioned thickness of the transparent dielectric layer 150 is exemplary and does not intend to limit the instant disclosure. For one of ordinarily skill in the art, the thickness of the transparent dielectric layer 150 may vary according to practical requirement.

As shown in FIG. 3B, the transparent insulating layer 140 is formed on the substrate 110, transparent electrode layer 120 and transparent dielectric layer 150. The transparent insulating layer 140 can be made of optical clear adhesive.

As shown in FIGS. 3C and 3D, the substrate 110 is cut and the touch control panel structure 100 is formed. The cutting knife 200 goes through the cutting line 210 that passes the metal wiring layer 130 and transparent dielectric layer 150. The cutting strength falls between 1500 and 4000 lb/m².

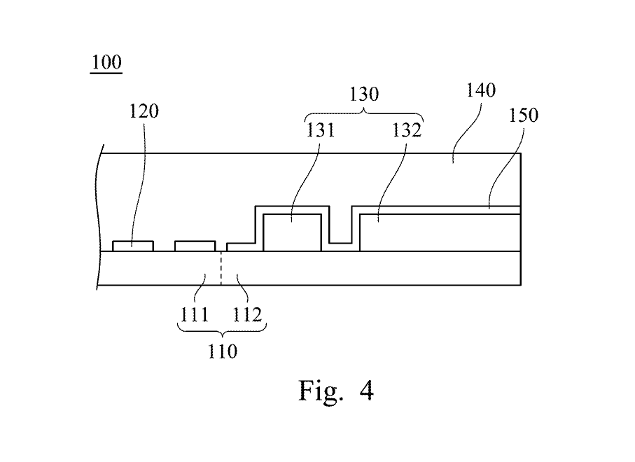

FIG. 4 is a cross-sectional view along line 2-2 in FIG. 1 showing the method of manufacturing touch control panel structure 100 in accordance with still another embodiment of the instant disclosure. The instant embodiment is similar to the abovementioned embodiment and the difference is elaborated hereinafter.

As shown in FIG. 4, the dielectric layer 140 is made of silicon oxides (SiOₓ), silicon nitrides (SiNₓ) or Al₂O₃. The transparent dielectric layer 150 has a thickness ranging between 5 and 100 nm, and the transparent dielectric layer 150 conformingly covers the metal wiring layer 130.

The transparent dielectric layer 150 may be formed by vapour deposition, and the instant disclosure is not limited thereto. In another embodiment, the transparent dielectric layer 150 is formed by screen printing.

As shown in FIGS. 1, 2G, 3D and 4, the instant disclosure also provides a touch control panel structure 100. The touch control panel structure 100 includes the substrate 110, transparent insulating layer 140, transparent electrode layer 120 and metal wiring layer 130. The substrate 110 has the display area 111 and the peripheral area 112. The peripheral area 112 surrounds the display area 111. The transparent insulating layer 140 is disposed on the substrate 110. The transparent electrode layer 120 is disposed between the display area 111 and the transparent insulating layer 140. In other words, the transparent electrode layer 120 is disposed on the display area 111. The metal wiring layer 130 is disposed between the peripheral area 112 and the transparent insulating layer 140. That is to say, the metal wiring layer 130 is disposed on the peripheral area 112. The edge of the metal wiring layer 130 is flushed against the edge of the substrate 110. More specifically, one side of the metal wiring layer 130 is exposed on one side of the touch control panel structure 100.

As shown in FIGS. 3D and 4, the touch control panel 100 further includes transparent dielectric layer 150, disposed in between the peripheral area 112 and the metal wiring layer 130 and the transparent insulating layer 140. In other words, the transparent dielectric layer 150 covers the peripheral area 112 and the metal wiring layer 130.

A side of the metal wiring layer 130 is coplanar with the outer edge of the substrate 110. When cutting the substrate 110 to form the touch control panel 100, the cutting knife 200 goes through the cutting line 210 which passes the metal wiring layer 130. As a result, the edge of the touch control panel 100 does not have a redundant area for cutting, and the frame is therefore narrower to achieve an even smaller size.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of manufacturing touch control panel structure, comprising:
providing a substrate;
forming a transparent electrode layer on a display area of the substrate;
forming a metal wiring layer on a peripheral area of the substrate, wherein the peripheral area surrounds the display area; and
cutting the substrate to form a touch control panel structure, wherein a cutting line goes through the metal wiring layer and an edge of the metal wiring layer is flushed against an edge of the substrate.

2. The method of claim 1, wherein the metal wiring layer has a thickness smaller than 10 μm.

3. The method of claim 1, wherein the metal wiring layer comprises an inner metal wiring and a peripheral metal wiring, a side of the peripheral metal wiring is flushed against the edge of the substrate, the cutting line goes through the peripheral metal wiring, and an interval between an outer edge of the inner metal wiring and the cutting line is 200 to 350 μm.

4. The method of claim 1, wherein a cutting strength is 1500 to 3100 lb/m².

5. The method of claim 1, further comprising:
forming a transparent dielectric layer on the peripheral area and the metal wiring layer, wherein the transparent dielectric layer is made of insulating polymers or metal oxides mixing with polymers, and the transparent dielectric layer has a thickness of 10 to 200 μm.

6. The method of claim 1, further comprising:
forming a transparent dielectric layer on the peripheral area and the metal wiring layer, wherein the transparent dielectric layer is made of non-conductive thin film, and an interval between an edge of the transparent dielectric layer proximate to the display area and the metal wiring layer is approximately 5 to 100 nm.

7. The method according to claim 6, wherein a cutting strength is 1500 to 4000 lb/m².

8. The method according to claim 1, wherein a cutting strength is 1500 to 4000 lb/m².

9. A touch control panel structure, comprising:
a substrate having a display area and a peripheral area, wherein the peripheral area surrounds the display area;
a transparent electrode layer disposed on the display area; and
a metal wiring layer disposed on the peripheral area, an edge of the metal wiring layer being flushed against an edge of the substrate.

10. The touch control panel structure of claim 8, wherein the metal wiring layer has a thickness smaller than 10 μm.

11. The touch control panel structure of claim 8, wherein the metal wiring layer comprises an inner metal wiring and a peripheral metal wiring, a side of the metal wiring layer is flushed against the edge of the substrate, and an interval between an outer edge of the inner metal wiring and a side of the touch control panel is 200 to 350 μm.

12. The touch control panel structure of claim 8, further comprising:
a transparent dielectric layer covering the peripheral area and the metal wiring layer.

13. The touch control panel structure of claim 11, wherein the transparent dielectric layer is made of insulating polymers or metal oxides mixing with polymers, and the transparent dielectric layer has a thickness of 10 to 200 μm.

14. The touch control panel structure of claim 11, wherein the transparent dielectric is made of non-conductive thin film, an interval between an edge of the transparent dielectric layer proximate to the display area and the metal wiring layer is 5 to 100 nm.
